(19) United States
(12) Patent Application Publication
(10) Pub. No.: US 2005/0134424 A1
(43) Pub. Date: Jun. 23, 2005

(54) Bimetallic strip for a circuit breaker

(76) Inventor: Albert Huang, Taipei (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/741,620

(22) Filed: Dec. 19, 2003

(51) Int. Cl. H01H 37/52

(52) U.S. Cl. 337/379; 337/362

(57) ABSTRACT

A bimetallic strip for a circuit breaker includes a substantially rectangular frame with two long sides, two short sides, a top side, and a bottom side. The long sides are slightly bent upwards. The first short side is securely mounted on the first terminal of the circuit breaker and has a length smaller than that of the second short side. A first saddle-like slot is defined at the first short side. A movable node mounted at the second short side and the bottom side. By means of changing the depth of the saddle-like slot, it is very easy for a manufacturer to make the metallic strips with various specifications of current ratings.

### BACKGROUND OF THE INVENTION

1. Field of the Invention

The present invention relates to a circuit breaker, and more particularly to a bimetallic strip for a circuit breaker.

2. Description of Related Art

A circuit breaker for terminating a circuit in an over-current status generally has a bimetallic strip which will become deformed under a high temperature to disconnect two terminals of the circuit breaker for protecting electrical appliances.

With reference to FIGS. 6-7, a conventional bimetallic strip (40) has two legs (41) separately formed at two sides of the bimetallic strip (40) and a tongue (42) formed between the two legs (41). A movable node (43) is formed on a free end of the tongue (42). The legs (41) are pressed inwards to close each other and mounted on a top of a terminal (50). By this means, the bimetallic strip (40) has a middle portion depressed and the tongue (42) is pressed downwards to connect the movable node (43) with an immovable node in a switched-on status. When the current of the circuit is in an overload status, the bimetallic strip (40) will become heated and deformed, and the middle portion of the bimetallic strip (40) will be protruded, and the movable node (43) is disconnected from the immovable node to terminate the circuit.

However, the legs (41) are securely mounted on the terminal, so it is difficult to adjust the sensitivity of the bimetallic strip (40) during manufacturing according to various appliances with different rated current specifications. Thus, the circuit breaker with this bimetallic strip does not have enough variability to safely protect appliances.

Therefore, the invention provides a bimetallic strip to mitigate or obviate the aforementioned problems.

### SUMMARY OF THE INVENTION

The main objective of the present invention is to provide a bimetallic strip which can be adjusted in manufacture to change its sensitivity to enable it to be adapted to various rated current specifications.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a metallic strip in accordance with the present invention;

FIG. 2 is an exploded perspective view of a second embodiment of the metallic strip and a terminal;

FIG. 3 is a perspective view of the second embodiment of the metallic strip assembled with the terminal;

FIG. 4 is a top view of a third embodiment of the metallic strip in accordance with the invention;

FIG. 5 is a perspective view of the third embodiment of the metallic strip assembled with the terminal;

FIG. 6 is a top view showing a processing of forming a conventional metallic strip; and

FIG. 7 is a perspective view of the conventional metallic strip assembled with a terminal.

### DETAILED DESCRIPTION OF THE PREFERRED EMBODIMENT

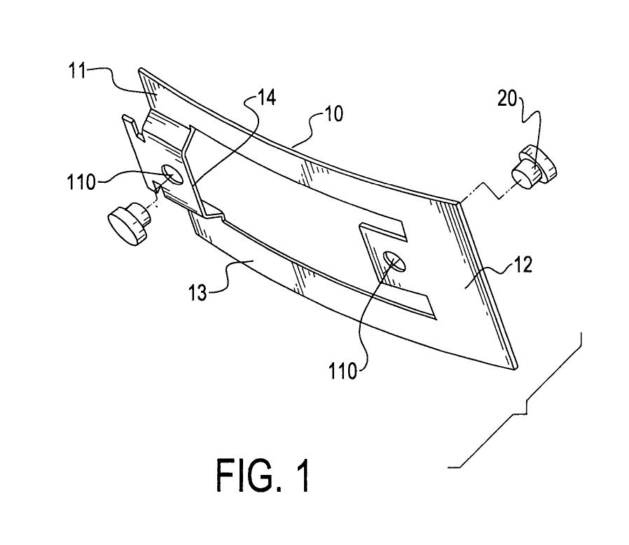

With reference to FIG. 1, in a first embodiment according to the present invention, a metallic strip (10) has a substantially rectangular frame with two long sides (13), a first short side (11), a second short side (12), a top side, and a bottom side. A saddle-like slot (14) is defined at the first short side (11) of the metallic strip (10) by means of punching to reduce a length of the first short side (11). Therefore, the long sides (13) will be slightly bent upwards after the punching process. Two holes (110) are respectively defined through the saddle-like slot (14) and the second short side (12).

The first short side (11) is securely mounted on a first terminal (not shown in this figure) of a breaker (not shown) by a fastener (not numbered) through the hole (110) of the saddle-like slot (14). A movable node (20) is mounted in the hole (110) of the second short side (12) and at the bottom side for connecting with/disconnecting from a second terminal (not shown) of the breaker when the current is in a normal/over-load status.

When the current is in an over-load status, the bimetallic strip (10) becomes hot and bends upwards. Because the first short side (11) is secured on the first terminal, the second short side (12) will rise to disconnect the movable node (20) from the second terminal and the circuit is terminated.

The sensitivity of the bimetallic strip (10) is inversely proportional to the depth of the slot (14). Namely, the bimetallic strip (10) with a deep slot (14) will have a low sensitivity, which is adapted to an appliance with a high current rating; whereas, the bimetallic strip (10) with a shallow slot (14) will have a high sensitivity, which is adapted to an appliance with a low current rating.

Therefore, during manufacture of the strip, to be adaptable to various rated current specifications, the metallic strip (10) can be made with the slot (14) with corresponding depths.

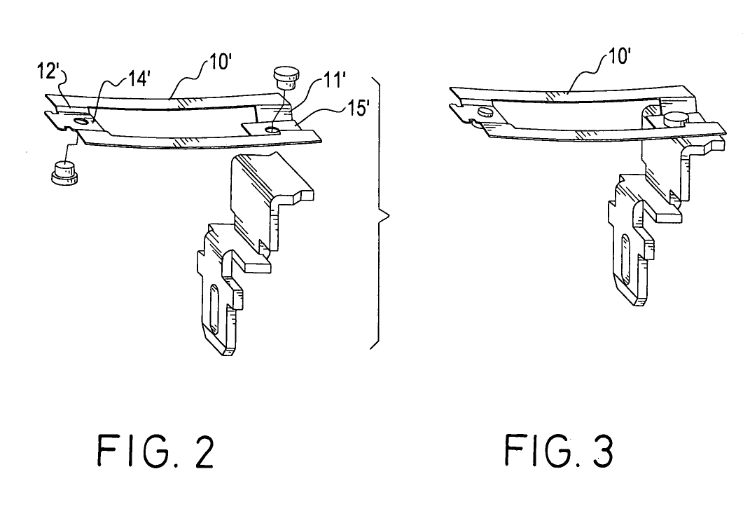

With reference to FIGS. 2-3, in a second embodiment of the present invention, the first short side (11′) of the metallic strip (10′) has a first saddle-like slot (15′), and the second short side (12′) of the metallic strip (10′) has a second saddle-like slot (14′) shallower than the first saddle-like slot (15′). The sensitivity of the metallic strip (10′) is inversely proportional to the depth difference between the first saddle-like slot (15′) and second saddle-like slot (14′). Thus, the metallic strip (10′) with a large depth difference between the slots (15′, 14′) will have a low sensitivity, which is adapted to an appliance with a high current rating; whereas, the bimetallic strip (10′) with a small depth difference between the slots (15′, 14′) will have a high sensitivity, which is adapted to an appliance with a low current rating.

Therefore, during manufacture, to adapt to various current rating specifications, the metallic strip (10′) can be made with the slots (15′, 14′) with corresponding depth differences.

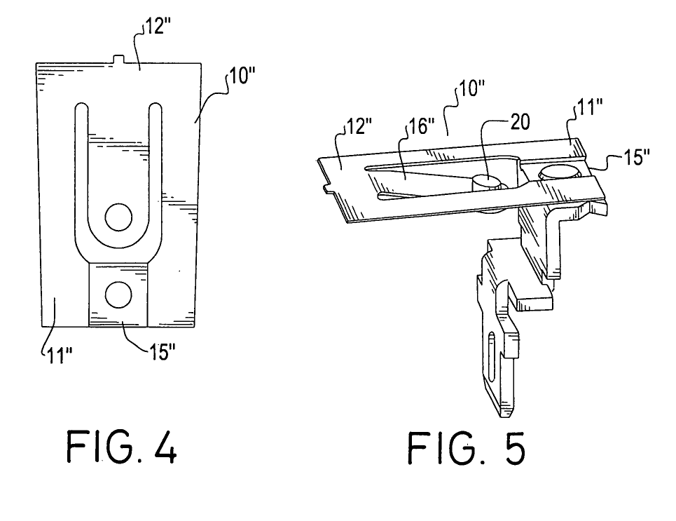

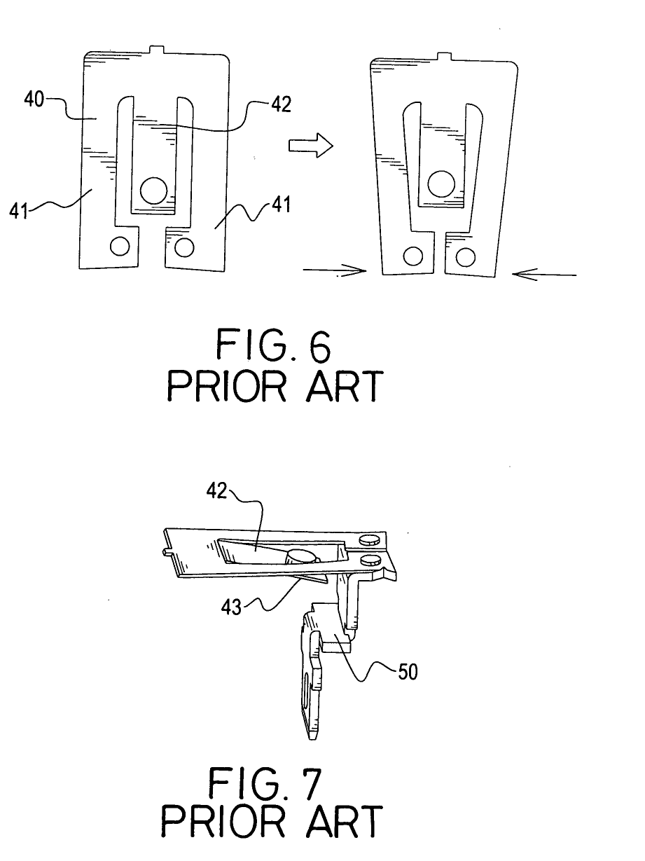

As illustrated in FIGS. 4-5, in a third embodiment, the metallic strip (10″) has a saddle-like slot (15″) defined at the first short side (11″). The first short side (11″) is shorter than the second short side (12″) and securely mounted on the first terminal (not numbered). A finger (16″) is formed at the second short side (12″) and extends towards the first short side (11″). The movable node (20) is mounted at a free end of the finger (16″).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A bimetallic strip adapted to a circuit breaker, the circuit breaker having two terminals, the bimetallic strip comprising:
a substantially rectangular frame with two long sides, two short sides, a top side, and a bottom side, wherein the long sides are slightly bent upwards, the first short side is adapted to be securely mounted on the first terminal of the circuit breaker and has a length smaller than a length of the second short side;
a first saddle-like slot defined at the first short side; and
a movable node mounted at the second short side and the bottom side.

2. The bimetallic strip as claimed in claim 1 further comprising a finger formed at the second short side and extending towards the first short side, and the movable node mounted a free end of the finger.

3. The bimetallic strip as claimed in claim 1 further comprising a second saddle-like slot defined at the second short side with a depth smaller than a depth of the first saddle-like slot.
